(19) United States
(12) Patent Application Publication
(10) Pub. No.: US 2005/0063387 A1
(43) Pub. Date: Mar. 24, 2005

(54) System and method of order reexamination in electronic data interchange

(76) Inventors: Lien-Hong Chen, Wu-Ku Hsiang (TW); Te-Lung Tsai, Wu-Ku Hsiang (TW); Liang-Ji Chen, Wu-Ku Hsiang (TW)

Correspondence Address: BIRCH STEWART KOLASCH & BIRCH, PO BOX 747, FALLS CHURCH, VA, 22040-0747, US

(21) Appl. No.: 10/667,411

(22) Filed: Sep. 23, 2003

(51) Int. Cl. H04L 12/28

(52) U.S. Cl. 370/394; 370/395.4

(57) ABSTRACT

A system of order reexamination in an EDI (electronic data interchange). The system includes an EDI server, a message conversion server and an order reexamination system. The EDI server receives an EDI message and transfers it to the message conversion system and the order reexamination system. The message conversion system transforms the EDI message into a first electronic order. The order reexamination system parses the EDI message to generate a second electronic order group. The order reexamination system generates a notification if order IDs in the first electronic order group do not match the second electronic order group or the quantity of orders in the first electronic order group is different from that of the second electronic order group.

### BACKGROUND OF THE INVENTION

1. Field of the Invention

The present invention relates to a system and method of order reexamination, and particularly to a system and method of order reexamination that ensures the accuracy of electronic orders in an EDI (Electronic Data Interchange) environment.

2. Description of the Related Art

With the advancement of information technology, enterprises are computerized to strengthen competitive ability and service quality. The computerized scope covers workflow between departments inside the enterprise and business models between enterprises.

EDI (Electronic Data Interchange) is a business model that enterprises do business by transferring electronic data in a standard format. EDI and related techniques have matured to solve business problems between enterprises. In an EDI environment, the enterprises can be fully computerized, thus most operations can be performed utilizing the convenience, automation and efficiency of computers and networks, thereby saving manpower and improving response time and efficiency.

In EDI operations, dedicated business data generated by an application system of a sender has to be converted to an EDI message with the standard format adopted by partners in advance. After the EDI message is received, it must be converted to data of a recognized format before being transferred to the application system, such as an order management system to perform related processes.

However, the conversion system that performs the conversion of EDI messages, such as GENTRAN server, can cause inaccuracies in orders extracted from the EDI messages. For example, orders may be lost when a large number of EDI messages are converted at one time, such that enterprises are still required to manually check orders with partners, thereby increasing business risks and costs, diluting the original value of EDI.

In addition, since the conversion system lacks effective error notification means if the conversion system is overloaded or malfunctions-based shutdown, the back-end application system remains unaware of the situation, causing order loss and business difficulties.

### SUMMARY OF THE INVENTION

It is therefore an object of the present invention to provide a system and method of order reexamination that ensures the accuracy of electronic orders in an EDI (Electronic Data Interchange) environment.

It is another object of the present invention to generate notification if orders are lost or the conversion system experiences malfunction.

To achieve the above objects, the present invention provides a system of order reexamination in EDI. The system includes an EDI server, a message conversion server, an order management system, and an order reexamination system.

The EDI server receives an EDI message and transfers it to the message conversion system and the order reexamination system. The message conversion system transforms the EDI message into a first electronic order group, and transfers it to the order management system. The order reexamination system parses the EDI message to generate a second electronic order group. The order reexamination system compares the first electronic order group from the order management system to the second electronic order group, and generates a notification or warning message if order IDs in the first electronic order group do not match the second electronic order group or the quantity of orders in the first electronic order group is different from that of the second electronic order group.

A method of order reexamination in an EDI according to the present invention is also provided. First, an EDI server receives an EDI message and transfers it to a message conversion system and an order reexamination system. Then, the message conversion system transforms the EDI message into a first electronic order group comprising a plurality of orders with respective order IDs.

Then, the order reexamination system parses the EDI message to generate a second electronic order group comprising a plurality of orders with respective order IDs. Thereafter, the first electronic order group and the second electronic order group are compared, and a notification is generated if the order IDs in the first order do not match the second order or the quantity of the orders in the first order is different from that of the second order.

### BRIEF DESCRIPTION OF THE DRAWINGS

The aforementioned objects, features and advantages of the invention will become apparent by referring to the following detailed description of the preferred embodiment with reference to the accompanying drawings, wherein:

FIG. 1 is a schematic diagram illustrating the architecture of the system of order reexamination in an EDI according to the present invention; and

FIG. 2 is a flowchart showing the method of order reexamination in an EDI according to the present invention.

### DETAILED DESCRIPTION OF THE INVENTION

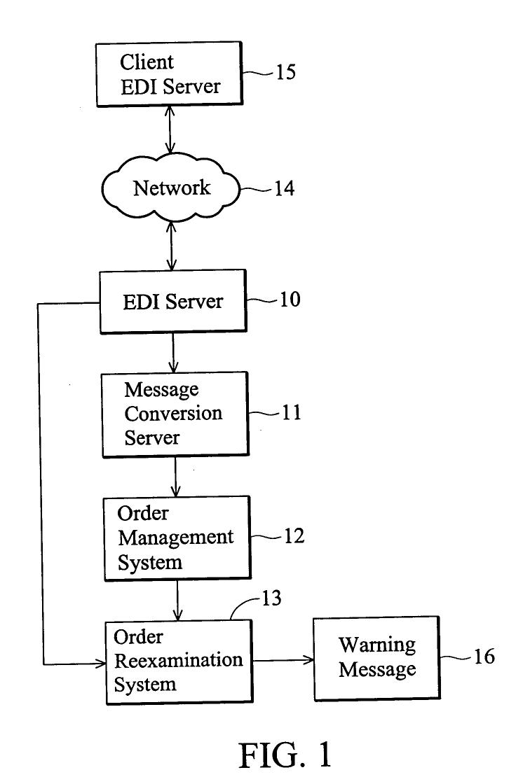

FIG. 1 illustrates the architecture of the system of order reexamination in an EDI (electronic data interchange) according to the present invention. The system includes an EDI server 10, a message conversion server 11, an order management system 12 and an order reexamination system 13 having an order conversion unit and a job scheduling module (not shown in FIG. 1).

The EDI server 10 follows the EDI standard. The EDI server 10 receives an EDI message from a client EDI server 15 via a network 14. The EDI server 10 may transfer the received EDI message to the message conversion system 11 and the order reexamination system 13.

The message conversion system 11 works as a GENTRAN server transforming EDI messages into electronic orders having a specific format recognized by the native application system. The message conversion system 11 may convert the received EDI message into a first electronic order group according to a standard EDI format, comprising a plurality of orders, each having a unique order ID. The first electronic order group is transferred to the order management system 12, such as the SAP system commonly used in industry for order dispatching, planning and management, and financial management.

In addition, the order reexamination system 13 may receive the EDI message from the EDI server 10. The order conversion unit of the order reexamination system 13 parses and divides the EDI message according to a specific definition symbol and format, thereby generating a second electronic order group comprising a plurality of orders, each having a unique order ID.

The job scheduling module of the order reexamination system 13 may obtain the first electronic order group from the order management system 12 in real time within a preset time interval, and compare the first electronic order group and the second electronic order group generated by the order conversion unit. If the order IDs in the first electronic order group do not match the second electronic order group or the quantity of orders in the first electronic order group is different from that of the second electronic order group, the order reexamination system 13 generates a notification or warning message 16 for system recovery in real time, and sends a signal to the order management system 12 to suspend the order management system 12. It should be noted that the order reexamination system 13 also generates the notification 16 to notify related users if the first electronic order group cannot be obtained from the order management system 12.

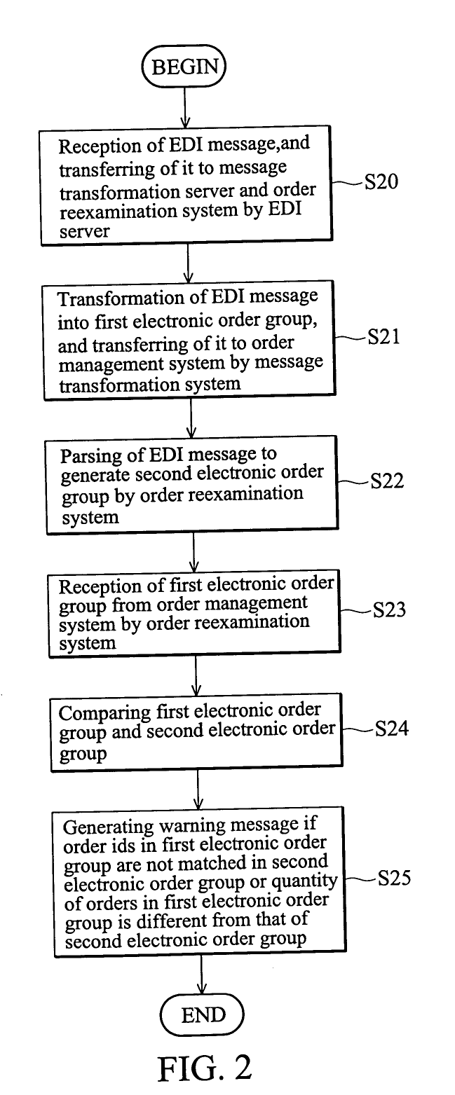

FIG. 2 shows the method of order reexamination in an EDI according to the present invention. First, in step S20, the EDI server 10 receives an EDI message from the client EDI server 15 via the network 14, and transfers the received EDI message to the message conversion system 11 and the order reexamination system 13. Then, in step S21, the message conversion system 11 transforms the EDI message into a first electronic order group according to the standard EDI format, and transfers it to the order management system 12.

Then, in step S22, the order reexamination system 13 parses and divides the EDI message to generate a second electronic order group. Thereafter, in step S23, the order reexamination system 13 obtains the first electronic order group from the order management system 12, and in step S24, compares the first electronic order group and the second electronic order group. If the order IDs in the first electronic order group do not match the second electronic order group or the quantity of orders in the first electronic order group is different from that of the second electronic order group, in step S25, the order reexamination system 13 generates a notification or warning message 16 for system recovery, and a suspend signal to the order management system 12.

Similarly, the order reexamination system 13 further generates another notification 16 for system recovery in real time if the first electronic order group cannot be obtained from the order management system 12.

As a result, using the system and method of order reexamination in an EDI according to the present invention, the accuracy of electronic orders in an EDI environment is ensured. In addition, if orders are lost or the conversion system malfunctions, a notification is automatically generated for system recovery in real time.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

1. A system of order reexamination in an EDI (electronic data interchange), comprising:
an EDI server to receive an EDI message;
a message conversion system coupled to the EDI server to receive the EDI message for conversion to a first electronic order comprising a plurality of orders, each having a unique order ID;
an order management system coupled to the message conversion system to receive the first electronic order; and
an order reexamination system coupled to the EDI server and the order management system to receive the EDI message and the first electronic order, the order reexamination system comprising:
an order conversion unit to parse the EDI message to generate a second electronic order group comprising a plurality of orders, each having a unique order ID; and
a job scheduling module to compare the first electronic order group and the second electronic order group, and generate a notification if the order IDs in the first electronic order group do not match the second electronic order group or the quantity of the orders in the first electronic order group is different from that of the second electronic order group.

2. The system of order reexamination in an EDI as claimed in claim 1 wherein the job scheduling module compares the first electronic order group and the second electronic order group within a preset time interval.

3. The system of order reexamination in an EDI as claimed in claim 2 wherein the job scheduling module further generates another notification if the first electronic order group is not received from the order management system.

4. The system of order reexamination in an EDI as claimed in claim 1 wherein the order conversion unit parses the EDI message according to a standard EDI format, thereby generating the second electronic order group.

5. The system of order reexamination in an EDI as claimed in claim 1 wherein the message conversion server is a GENTRAN server.

6. The system of order reexamination in an EDI as claimed in claim 1 wherein the job scheduling module further sends a signal to suspend the order management system if the order IDs in the first electronic order group do not match the second electronic order group or the quantity of the orders in the first electronic order group is different from that of the second electronic order group.

7. A method of order reexamination in an EDI (electronic data interchange), comprising the steps of:
reception of an EDI message by an EDI server;
reception of the EDI message from the EDI server, and conversion of the EDI message into a first electronic order group by a message conversion system comprising a plurality of orders, each having a unique order ID;
receipt of the EDI message from the EDI server by an order reexamination system;
parsing of the EDI message to generate a second electronic order group by the order reexamination system, in which the second electronic order group has a plurality of orders, each having a unique order ID; and
comparison of the first electronic order group and the second electronic order group, and generation of a notification by the order reexamination system if the order IDs in the first electronic order group do not match the second electronic order group or the quantity of the orders in the first electronic order group is different from that of the second electronic order group.

8. The method of order reexamination in an EDI as claimed in claim 7 further comprising transfer of the first electronic order group to an order management system by the message conversion system, and acquisition of the first electronic order group from the order management system by the order reexamination system.

9. The method of order reexamination in an EDI as claimed in claim 8 wherein the first electronic order group and the second electronic order group are compared within a preset time interval.

10. The method of order reexamination in an EDI as claimed in claim 9 further comprising generation of another notification by the order reexamination system if the first electronic order group is not acquired.

11. The method of order reexamination in an EDI as claimed in claim 7 wherein the EDI message is parsed according to a standard EDI format, thereby generating the second electronic order group.

12. The method of order reexamination in an EDI as claimed in claim 7 wherein the message conversion server is a GENTRAN server.

13. The method of order reexamination in an EDI as claimed in claim 8 further comprising sending a signal to suspend the order management system sent by the order reexamination system if the order IDs in the first electronic order group do not match the second electronic order group or the quantity of the orders in the first electronic order group is different from that of the second electronic order group.
